(19) United States
(12) Patent Application Publication
(10) Pub. No.: US 2016/0270445 A1
(43) Pub. Date: Sep. 22, 2016

(54) ELECTRONIC CIGARETTE

(71) Applicant: KIMREE HI-TECH INC., Tortola (VG)

(72) Inventor: Qiuming Liu, Shenzhen, Guangdong (CN)

(21) Appl. No.: 15/029,694

(22) PCT Filed: Oct. 15, 2013
(86) PCT No.: PCT/CN2013/085256

§ 371 Date: Apr. 15, 2016

(51) Int. Cl. A24F 47/00; H05B 3/00; H05B 3/03; H01M 2/10

(52) U.S. Cl. CPC A24F 47/008; H01M 2/105; H05B 3/0014; H05B 3/03; H01M 2220/30

(57) ABSTRACT

An electronic cigarette, comprising an outer casing (1), and a vaporization assembly (2) and battery assembly (3) mounted inside the outer casing (1); the electronic cigarette further comprises an electrical connector (4) mounted inside the outer casing (1); the vaporization assembly (2) comprises at least one vaporizer (22); one end of the electrical connector (4) resiliently abuts against each vaporizer (22), and the other end of the electrical connector (4) resiliently abuts against the battery assembly (3). The configuration of the two ends of the electrical connector of the electronic cigarette resiliently abutting against the vaporizers (22) and the battery assembly (3) is such that assembly of the electronic cigarette is simple, which is advantageous for automated assembly and production.

### TECHNICAL FIELD

The present invention relates to the technical field of daily electronic products, and more particularly, relates to an electronic cigarette.

### BACKGROUND

Electronic cigarettes are used for smoking cessation and substitute for traditional cigarettes. An electronic cigarette of the prior art includes an outer sleeve, a vaporization assembly and a battery assembly. The vaporization assembly and the battery assembly are both arranged in the outer sleeve. The vaporization assembly comprises at least one electric heater coil. Normally, the electric heater coils are electrically connected to the battery assembly by welding wires, but this mode of welding wires is comparatively inconvenient in combing wires and complicated in assembly process, which results in a low production efficiency of electronics cigarettes, moreover, if there are a plurality of the electric heater coils, the assembly process will be more complicated.

### DISCLOSURE OF THE PRESENT APPLICATION

### Technical Problems

The objective of the present invention is to provide an electronic cigarette, which is comparatively convenient to assemble a vaporization assembly and a battery assembly, aiming at the drawbacks in the prior art that, it is complicated to achieve a connection structure of the vaporization assembly and the battery assembly.

### Solutions to Technical Problems

### Technical Solutions

Technical solutions applied for the present application to solve the technical problems are to provide an electronic cigarette, which includes an outer sleeve, a vaporization assembly and a battery assembly; the vaporization assembly and the battery assembly are both arranged in the outer sleeve; the electronic cigarette further comprises an electrical connector which is installed inside the outer sleeve; wherein the vaporization assembly comprises at least one vaporizer; one end of the electrical connector is resiliently abutted against the at least one vaporizer respectively while the other end of this is resiliently abutted against the battery assembly.

In the electronic cigarette of the present application, wherein the vaporization assembly comprises two or more vaporizers and a fixing sleeve which is utilized to accommodate all the vaporizers; the fixing sleeve is fixed inside the outer sleeve and is provided with numbers of accommodation spaces corresponding numbers and shapes of the vaporizers; the each vaporizer is accommodated in the each accommodate space correspondingly.

In the electronic cigarette of the present application, wherein the battery assembly includes a first electrode and a second electrode; the each vaporizer includes a first electrode connecting portion and a second electrode connecting portion which are arranged on a side of the fixing sleeve near to the first electrode; the electrical connector includes a first electrical connector which is resiliently abutted between the first electrode and the first electrode connecting portion, and a second electrical connector which is resiliently abutted between the second electrode and the second electrode connecting portion.

In the electronic cigarette of the present application, wherein a first electrical connector includes a fixing support, and first elastic electrode posts and a second elastic electrode post which are arranged on two opposite sides of the fixing support; the number of the first elastic electrode posts is equal to that of first electrode connecting portions, and the each first elastic electrode post is resiliently against a first electrode connecting portion. The second elastic electrode post is resiliently abutted against the first electrode.

In the electronic cigarette of the present application, wherein the first elastic electrode posts and the second elastic electrode post are made of conductive silica gel or conductive rubber.

In the electronic cigarette of the present application, wherein the each first elastic electrode post includes a first installing base which is installed on the fixing support, a first stretch portion which is retractably installed on the first installing base and is resiliently abutted against a first electrode connecting portion, and a first elastic portion which is resiliently abutted between the first stretch portion and the first installing base.

In the electronic cigarette of the present application, wherein the second elastic electrode post includes a second installing base which is installed on the fixing support, a second stretch portion which is retractably installed in the second installing base and is resiliently abutted against the first electrode, and a second elastic portion which is resiliently abutted between the second stretch portion and the second installing base.

In the electronic cigarette of the present application, wherein the fixing support is fixed on an end surface of the fixing sleeve and electrically connected to the first elastic electrode post and the second elastic electrode post.

In the electronic cigarette of the present application, wherein the fixing support is provided with a conductive elastic arm for resiliently abutting against an inner wall of the outer sleeve; the outer sleeve is electrically connected to the conductive elastic arm and a control module of the vaporization assembly.

In the electronic cigarette of the present application, the first electrode and the second electrode locate on two opposite sides of the battery assembly. The electronic cigarette includes a connecting support which is defined on one end of the battery assembly where the first electrode locates and is electrically connected with the second electrode; the second electrical connector is the third elastic electrode posts whose quantity is equal to that of the second electrode connecting portions. Each third elastic electrode post is resiliently abutted against the connecting support, and the third elastic electrode post is resiliently against a second electrode connecting portion correspondingly.

In the electronic cigarette of the present application, the third elastic electrode posts are fixed on an end surface of the fixing sleeve.

In the electronic cigarette of the present application, the third elastic electrode posts are made of conductive silica gel or conductive rubber.

In the electronic cigarette of the present application, wherein the each third elastic electrode post includes a third installing base, a third installing base, a third stretch portion, a forth stretch portion and a third elastic portion. The third stretch portion and the forth stretch portion are retractably installed on both ends of the third installing base; the third elastic portion is resiliently abutted between the third stretch portion and the forth stretch portion. The third stretch portion is resiliently abutted against a second electrode connecting portion; the each forth stretch portion is resiliently abutted against the connecting support.

In the electronic cigarette of the present application, wherein the connecting support includes a support body and an installing hole which is arranged in the support body; one end of the battery assembly is sheathed in the installing hole.

In the electronic cigarette of the present application, wherein the connecting support further comprises an electrical connection portion which extends in a direction from the support body towards the second electrode. The electrical connection portion is electrically connected with the second electrode by wires.

In the electronic cigarette of the present application, wherein the each vaporizer further comprises an insulation portion which is arranged between the first electrode connecting portion and the second electrode connecting portion.

In the electronic cigarette of the present application, wherein the electronic cigarette further comprises a suction nozzle which is in a shape of a thin strip and arranged at one end of the outer sleeve in the direction far away the battery assembly.

In the electronic cigarette of the present application, wherein an opening end for picking and placing the vaporizer locates on one end of the outer sleeve which is away from the battery assembly; the at least one vaporizer is removably connected with the outer sleeve.

In the electronic cigarette of the present application, one end of the battery assembly which is away from the vaporization assembly is removably connected with the outer sleeve.

### Advantageous Effect

### Technical Effect

With application of the electronic cigarette according to the present invention, the following advantages can be achieved: by applying a structure that one end of the electrical connector is resiliently abutted against each vaporizer respectively while the other end of this is resiliently abutted against the battery assembly, it is easy and simple to operate the assembling process of the electronic cigarette and beneficial to the assembling production of automation.

### BRIEF DESCRIPTION OF THE DRAWINGS

The embodiments of the present invention or the technical solution will be further described with reference to the accompanying drawings and embodiments in the following.

FIG. 1 is an explosive view of a preferred embodiment of the electronic cigarette provided in the present invention;

FIG. 2 is a schematic diagram of the electronic cigarette shown in FIG. 1;

FIG. 3 is a schematic diagram of internal structures of the electronic cigarette shown in FIG. 1;

FIG. 4 is an amplify view of part A shown in FIG. 3;

FIG. 5 is a perspective view of a first electrical connector of the electronic cigarette shown in FIG. 1;

FIG. 6 is another perspective view of a first electrical connector of the electronic cigarette shown in FIG. 1;

FIG. 7 is a schematic diagram of internal structures of a first electrical connector of the electronic cigarette shown in FIG. 1;

FIG. 8 is a perspective view of a connecting support of the electronic cigarette shown in FIG. 1; and

FIG. 9 is a schematic diagram of internal structures of a third elastic electrode post of the electronic cigarette shown in FIG. 1.

### DETAILED DESCRIPTION OF THE PREFERRED EMBODIMENT

The technical feature, object and effect of the embodiments of the present invention will be clearly and completely described with reference to the accompanying drawings.

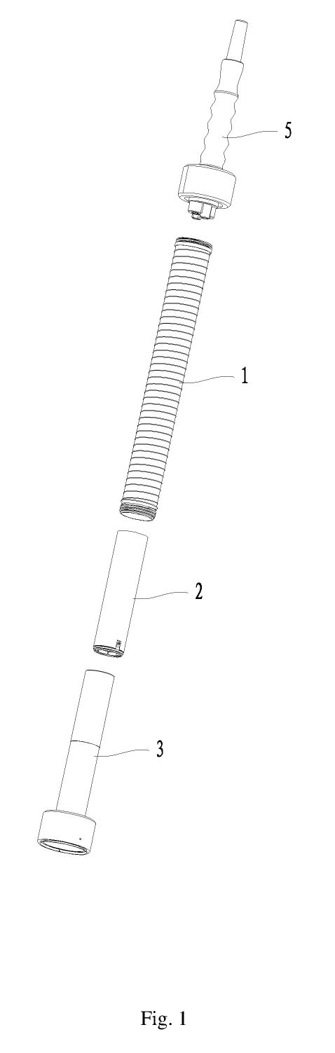

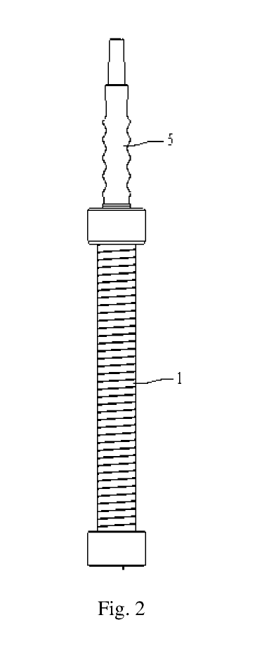

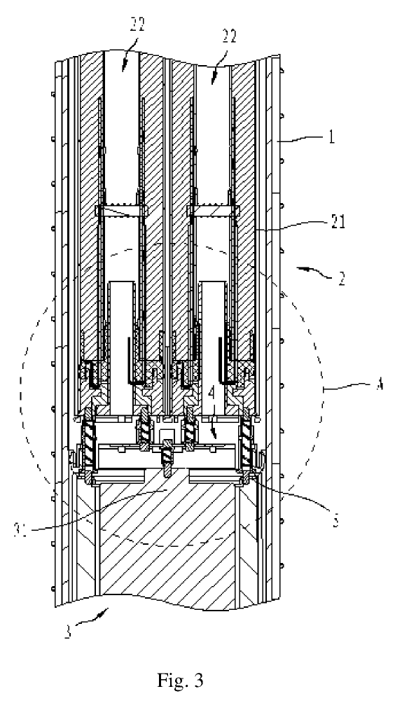

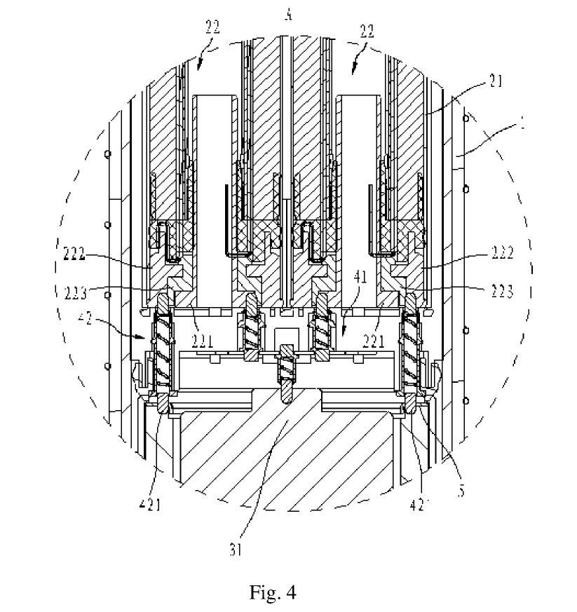

As shown in FIG. 1, FIG. 2, FIG. 3 and FIG. 4, a preferred embodiment of the present invention is provided with an electronic cigarette which includes an outer sleeve 1, a vaporization assembly 2, a battery assembly 3, an electrical connector 4, a connecting support5 and a suction nozzle 6.

In this case, specifically, as shown in FIG. 1, FIG. 2 and FIG. 3, the outer sleeve 1 is generally a hollow cylindrical structure. The vaporization assembly 2, the battery assembly 3 and the electrical connector 4 can be all removably installed inside the outer sleeve 1. An opening end (not labeled in figures) locates on one end of the outer sleeve 1 which is far away from the battery assembly 3. It is convenient to removing and installing the vaporization assembly 2 through the opening end. One end of the battery assembly 3 which is far away from the vaporization assembly 2 is removably connected with the outer sleeve 1, thus the electronic cigarette in the present invention has a compact structure, but is also convenient to assembly and replacement of the battery. It should be understood that the connection mode of the removable connection can be threaded or buckled connection, etc., in this embodiment, the connection mode of the removable connection is threaded connection. The suction nozzle 6 is in a shape of a thin strip and arranged at one end of the outer sleeve 1 in the direction far away the battery assembly 3.

As shown in FIG. 3 and FIG. 4, the vaporization assembly 2 includes a fixing sleeve 21 and a vaporizer 22. The fixing sleeve 21 which is generally a hollow cylindrical structure and removably installed inside the outer sleeve 1, the fixing sleeve 21can be utilized to accommodate the vaporizer 22. At least one vaporizer 22 is required, the fixing sleeve 21 is provided with numbers of accommodation spaces corresponding to numbers and shapes of the vaporizers, each vaporizer22 is accommodated in one accommodation space correspondingly, which means that the removable connection between the vaporizer 22 and the outer sleeve 1 can be achieved. The vaporizer 22 can be stably and reliably fixed and conveniently assembled by applying the structure of the fixing sleeve 21.Moreover, when the tobacco tar in the vaporizer 22 is exhausted, the vaporizer 22 can be replaced by turning on the suction nozzle. In this embodiment, two vaporizers are defined and evenly distributed in the fixing sleeve 21. Each vaporizer 22 includes a first electrode connecting portion 221 and a second electrode connecting portion 222 which are arranged on a side of the fixing sleeve 21 near to the battery assembly 3, and besides, an insulation portion 223 is arranged between the first electrode connecting portion 221 and the second electrode connecting portion 222. The first electrode connecting portion 221, the second electrode connecting portion 222 and the insulation portion 223 are generally hollow columnar structures, and the second electrode connecting portion 222 is sheathed on the external side of the first electrode connecting portion 221. The first electrode connecting portion 221 and the second electrode connecting portion 222 are resiliently abutted against the electrical connector 4 and the battery assembly 3 respectively to realize an electrical connection. The other end of the first electrode connecting portion 221and the second electrode connecting portion 222 are electrically connected to electric heater coil in the vaporizer 22 (not labeled in figures), other remaining parts in the vaporizer 22 are the prior arts, no more tautology here.

As shown in FIG. 3 and FIG. 4, the battery assembly 3 includes a first electrode 31 and a second electrode (not labeled in figures). The first electrode 31 and the second electrode are provided on two opposite sides of the battery assembly 3, and common dry batteries can be applied in the battery assembly 3. The first electrode 31 is connected with the first electrode connecting portion 221 of each vaporizer 22 to realize an electrical connection while the second electrode is connected with the second electrode connecting portion 222 of each vaporizer 22 to realize an electrical connection.

As shown in FIG. 3 and FIG. 4, an electrical connector 4 is utilized to realize an resilient abutting between each vaporizer 22 and the battery assembly 3. The electrical connector includes a first electrical connector 41 which is resiliently abutted between the first electrode 31 and the first electrode connecting portion 221, and a second electrical connector 42 which is resiliently abutted between the second electrode and the second electrode connecting portion 222.

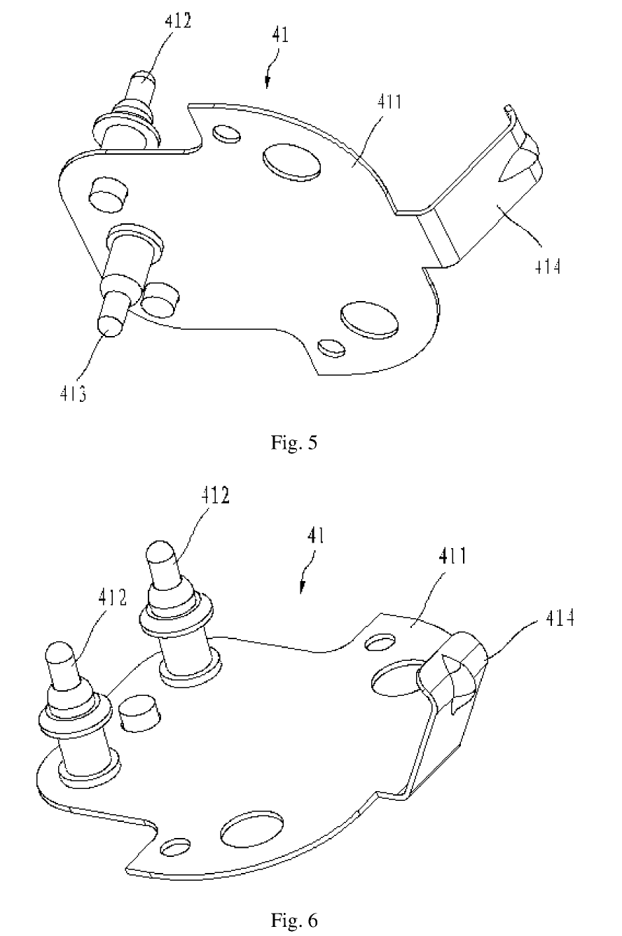

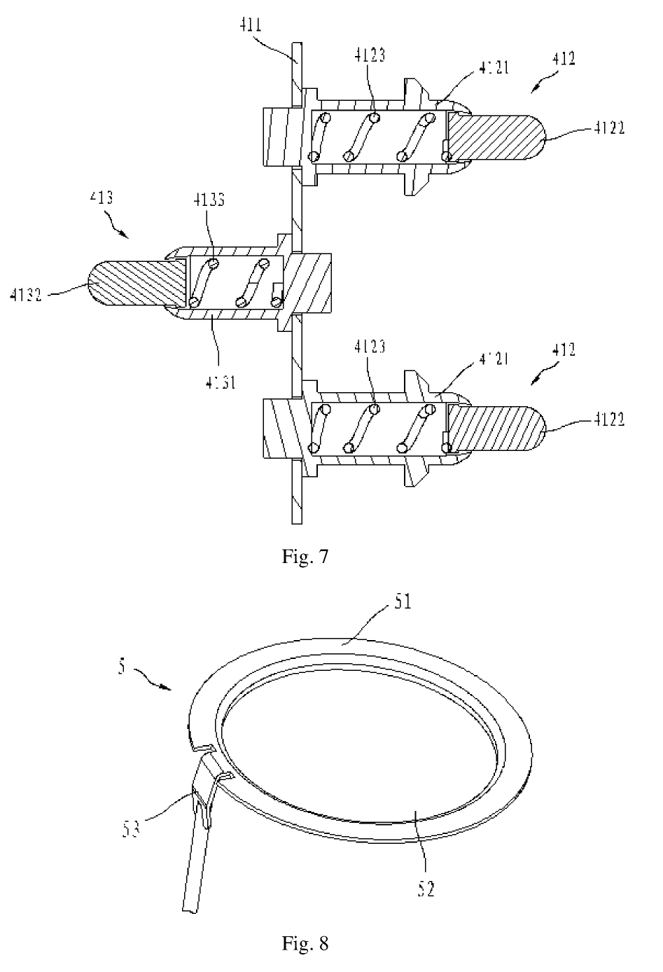

As shown in FIG. 5, FIG. 6, FIG. 7 and referring FIG. 4, the first electrical connector 41 includes a fixing support 411, and a first elastic electrode post 412, a second elastic electrode post 413 and a conductive elastic arm 414. The fixing support 411 is made by conductive materials and is approximately a sheet structure. The fixing support 411 is fixed on one end surface of the fixing sleeve 21andelectrically connected to the first elastic electrode post 412 and the second elastic electrodepost413, with this structure, it is unnecessary to apply additional wires for connecting the first elastic electrode post 412 and the second elastic electrode post 413. The first elastic electrode post 412 and the second elastic electrode post 413 are fixed on two opposite sides of the fixing support 411. The number of the first elastic electrode posts 412 is equal to that of the first electrode connecting portions 221, and the each first elastic electrode post 412 is resiliently abutted against the first electrode connecting portion 221 correspondingly to realize an electrical connection. The second elastic electrode post 413 is resiliently abutted against the first electrode 31 to realize an electrical connection. Specifically, each first elastic electrode post 412 includes a first installing base 4121 which is installed on the fixing support 411, a first stretch portion 4122 and a first elastic portion 4123 which is resiliently abutted between the first stretch portion 4122 and the first installing base 4121. The first stretch portion 4122 can be retractably installed on the first installing base 4121 and is resiliently abutted against the first electrode connecting portion 221, therefore, an electrical connection between the first elastic electrode post 412 and the first electrode connecting portion 221 can be achieved. The second elastic electrode post 413 includes a second installing base 4131 which is installed on the fixing support 411, a second stretch portion 4132 and a second elastic portion 4133 which is resiliently abutted between the second stretch portion 4132 and the second installing base 4131. The second stretch portion 4132 is retractably installed in the second installing base 4131 and is resiliently abutted against the first electrode 31, therefore, an electrical connection between the second elastic electrode post 413 and the first electrode 31 can be achieved. In other embodiments of the present invention, the first elastic electrode post 412 and the second elastic electrode post 413 are both made of conductive silica gel or conductive rubber which has well elastic and conductive properties.

As shown in FIG. 5, FIG. 6, FIG. 7 and referring FIG. 4, the conductive elastic arm 414 locates on the fixing support 411 and extends from one side of the fixing support 411towards to an inner side wall of the outer sleeve 1. The conductive elastic arm 414 is resiliently abutted against the inner sidewall of the outer sleeve 1 to realize an electrical connection; a control modular (not labeled in figures) for controlling an operation of the vaporization assembly2 is resiliently abutted against the inner sidewall of the outer sleeve 1; the inner sidewall of the outer sleeve 1is made of conductive materials to achieve an electrical connection between the conductive elastic arm 414 and the control modular, namely the electrical connection between the first electrode 3 1 andthe control modular is realized as well. With this structure of the conductive elastic arm 414, it is unnecessary to apply additional wires for connecting the first elastic electrode post 412 and the second elastic electrode post 413.

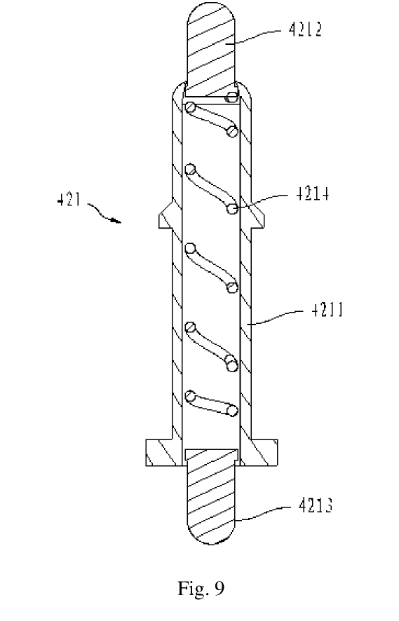

As shown in FIG. 8, FIG. 9 and referring FIG. 4, the second electrical connector 42 is the third elastic electrode post 421. The number of the third elastic electrode posts 421 is equal to that of the second electrode connection portions 222. The third elastic electrode post 421is fixed on the end surface of the fixing sleeve 21 to facilitate the assembly of the electronic cigarette. The connecting support 5 is sheathed on one end of the battery assembly 3 where the first electrode 31 locates and is electrically connected with the second electrode. Each third elastic electrode post 421 is resiliently abutted against the connecting support 5 to achieve an electrical connection, and the third elastic electrode post 421 is resiliently abutted against the second electrode connecting portion 222 correspondingly to realize an electrical connection.

Specifically, the connecting support 5 includes a support body 51, an installing hole 52 which is arranged on the support body 51, and an electrical connection portion 53 which extends in a direction from the support body 51 towards the second electrode. The installing hole 52 is installed on one end of the battery assembly 3. The electrical connection portion 53 is connected with the second electrode by wires to achieve an electrical connection between the second electrode and the second electrical connector 42. Each third elastic electrode post 421 includes a third installing base 4211, a third stretch portion 4212, a forth stretch portion 4213 and a third elastic portion 4214. The third stretch portion 4212 and the forth stretch portion 4213 are removably installed on both ends of the third installing base 4211; the third elastic portion 4214 is resiliently abutted between the third stretch portion 4212 and the forth stretch portion 4213. The third stretch portion 4212 is resiliently abutted against a second electrode connecting portion 222 correspondingly to achieve an electrical connection; the each forth stretch portion 4213 is resiliently abutted against the connecting support 5 to realize an electrical connection. In other embodiments of the present invention, the third elastic electrode post 421 is made of conductive silica gel or conductive rubber which has well elastic and conductive properties.

With application of the electronic cigarette according to the present invention, by applying a structure that one end of the electrical connector 4 is resiliently abutted against each vaporizer 22 respectively while the other end of this is resiliently abutted against the battery assembly 3, it is easy and simple to operate the assembling process of the electronic cigarette and beneficial to the assembling production of automation.

Combining with the accompanying drawings, embodiments of the present invention are described. However, the present invention is not limited by the above embodiments, which means that the above specific embodiments are only schematic, rather than restrictive. It should be understood that, in the inspiration of the present invention, those skilled in the art who appreciate and realize all or part of the process in above embodiments may make many modifications or alternatives, without going beyond the purpose and the scope the claims intend to protect of the present application. All these belong to the protection of the present invention.

1. An electronic cigarette, comprising an outer sleeve (1), a vaporization assembly (2) and a battery assembly (3), the vaporization assembly (2) and the battery assembly (3) are both arranged in the outer sleeve (1); wherein the electronic cigarette further comprises an electrical connector (4) in the outer sleeve (1); the vaporization assembly (2) comprises at least one vaporizer (22); one end of the electrical connector (4) is resiliently abutted against the vaporizer (22) respectively while the other end of electrical connector (4) is resiliently abutted against the battery assembly (3).

2. The electronic cigarette according to claim 1, wherein the vaporization assembly (2) comprises two or more vaporizers (22) and a fixing sleeve (21) which is utilized to accommodate the vaporizers (22); the fixing sleeve (21) is fixed inside the outer sleeve (1) and is provided with numbers of accommodation spaces corresponding to numbers and shapes of the vaporizers (22); each vaporizer (22) is accommodated in the each accommodation space correspondingly.

3. The electronic cigarette according to claim 2, wherein the battery assembly (3) includes a first electrode (31) and a second electrode; the each vaporizer (22) includes a first electrode connecting portion (221) and a second electrode connecting portion (222) which are arranged on one side of the fixing sleeve (21) near to the first electrode (31);
wherein the electrical connector (4) includes a first electrical connector (41) which is resiliently abutted between the first electrode (31) and the first electrode connecting portion (221), and a second electrical connector (42) which is resiliently abutted between the second electrode and the second electrode connecting portion (222).

4. The electronic cigarette according to claim 3, wherein the first electrical connector (41) includes a fixing support (411), and first elastic electrode posts (412) and a second elastic electrode post (413), the first elastic electrode posts (412) and the second elastic electrode post (413) are fixed on two opposite sides of the fixing support (411); and
wherein the number of the first elastic electrode posts (412) is equal to that of the first electrode connecting portions (221), and each first elastic electrode post (412) is resiliently abutted against the first electrode connecting portion (221), the second elastic electrode post (413) is resiliently abutted against the first electrode (31).

5. The electronic cigarette according to claim 4, wherein the first elastic electrode post (412) and the second elastic electrode post (413) are made of conductive silica gel or conductive rubber.

6. The electronic cigarette according to claim 4, wherein the each first elastic electrode post (412) includes a first installing base (4121), a first stretch portion (4122) and a first elastic portion (4123);
wherein the first installing base (4121) is installed on the fixing support (411), the first stretch portion (4122) is retractably installed on the first installing base (4121) and resiliently abutted against a first electrode connecting portion (221), and the first elastic portion (4123) is resiliently abutted between the first stretch portion (4122) and the first installing base (4121).

7. The electronic cigarette according to claim 4, wherein the second elastic electrode post (413) includes a second installing base (4131), a second stretch portion (4132) and a second elastic portion (4133),
wherein the second installing base (4131) is installed on the fixing support (411), the second stretch portion (4132) is retractably installed in the second installing base (4131) and resiliently abutted against the first electrode (31), and the second elastic portion (4133) is resiliently abutted between the second stretch portion (4132) and the second installing base (4133).

8. The electronic cigarette according to claim 4, wherein the fixing support (411) is fixed on an end surface of the fixing sleeve (21) and electrically connected to the first elastic electrode post (412) and the second elastic electrode post (413).

9. The electronic cigarette according to claim 8, wherein the fixing support (411) is provided with a conductive elastic arm (414) for resiliently abutting against an inner wall of the outer sleeve (1); and
the outer sleeve (1) is electrically connected to the conductive elastic arm (414) and a control module of the vaporization assembly (2).

10. The electronic cigarette according to claim 3, wherein the first electrode (31) and the second electrode are provided on two opposite sides of the battery assembly (3);
wherein the electronic cigarette further includes a connecting support (5) which is sheathed on one end of the battery assembly (3) where the first electrode (31) locates and is electrically connected with the second electrode; the second electrical connector (42) is third elastic electrode posts (421) whose quantity is equal to that of the second electrode connecting portions (222); and
wherein each third elastic electrode post (421) is resiliently abutted against the connecting support (5), and the each third elastic electrode post (421) is resiliently abutted against a second electrode connecting portion (222) correspondingly.

11. The electronic cigarette according to claim 10, wherein the each third elastic electrode post (421) is fixed on an end surface of the fixing sleeve (21).

12. The electronic cigarette according to claim 10, wherein the each third elastic electrode post (421) is made by conductive silica gel or conductive rubber.

13. The electronic cigarette according to claim 10, wherein the each third elastic electrode post (421) includes a third installing base (4211), a third stretch portion (4212), a forth stretch portion (4213) and a third elastic portion (4214);
wherein the third stretch portion (4212) and the forth stretch portion (4213) are retractably installed on both ends of the third installing base (4211); and
wherein the third elastic portion (4214) is resiliently abutted between the third stretch portion (4212) and the forth stretch portion (4213); the third stretch portion (4212) is resiliently abutted against a second electrode connecting portion (222); each forth stretch portion (4213) is resiliently abutted against the connecting support (5).

14. The electronic cigarette according to claim 10, wherein the connecting support (5) includes a support body (51) and an installing hole (52) which is arranged in the support body (51); one end of the battery assembly (3) is sheathed in the installing hole (52).

15. The electronic cigarette according to claim 14, wherein the connecting support (5) further comprises an electrical connection portion (53) which extends in a direction from the support body (51) towards the second electrode; the electrical connection portion (53) is electrically connected with the second electrode by wires.

16. The electronic cigarette according to claim 3, wherein the each vaporizer (22) further comprises an insulation portion (223) which is arranged between the first electrode connecting portion (221) and the second electrode connecting portion (222).

17. The electronic cigarette according to claim 1, wherein the electronic cigarette further comprises a suction nozzle (6) which is in a shape of a thin strip and arranged at one end of the outer sleeve (1) in the direction far away the battery assembly (3).

18. The electronic cigarette according to claim 1, wherein an opening end for picking and placing the vaporization assembly (2) locates on one end of the outer sleeve (1) which is away from the battery assembly(3), and the vaporizer (22) is removably connected with the outer sleeve(1).

19. The electronic cigarette according to claim 1, wherein one end of the battery assembly (3) which is away from the vaporization assembly (2) is removably connected with the outer sleeve (1).
